(19) United States
(12) Patent Application Publication
(10) Pub. No.: US 2015/0254761 A1
(43) Pub. Date: Sep. 10, 2015

(54) SYSTEM AND METHOD FOR MERCHANT BIDDING PROCESS

(71) Applicants: Jason Lyle Conway, Bellevue, WA (US); Kelly Miyake Ogilvie, Seattle, WA (US)

(72) Inventors: Jason Lyle Conway, Bellevue, WA (US); Kelly Miyake Ogilvie, Seattle, WA (US)

(73) Assignee: Quemulus, Inc., Bellevue, WA (US)

(21) Appl. No.: 14/200,403

(22) Filed: Mar. 7, 2014

(51) Int. Cl. G06Q 30/08; G06Q 50/00

(52) U.S. Cl. CPC G06Q 30/08; G06Q 50/01

(57) ABSTRACT

The present embodiment of the invention relates generally to a system and method for facilitating merchant bidding in an interne based, user driven e-commerce market (“Cloud Market”) by enabling bidders to place bids on a user's allocated funds (“Money Cloud”) using the bidder's specific goods and/or services for which align with the user's advertised intentions.

### BACKGROUND OF THE INVENTION

The concept of online bidding in an e-commerce market is dated. The conventional method of online bidding consists of a user's bidding for a competitive price on goods or services that a merchant has for sale. EBay's patent on Method for Internet Bidding Application (application Ser. No 13/867619) states and describes a method for an online bidding system. In this dated method, a user has to bid a higher amount than the previous user to “win” the good or service. This process shifts bargaining power to the merchant selling the good or service.

Additionally, conventional methods of bidding do not incorporate financial planning

Accordingly, an objective of the present invention is to provide mechanisms to create, save, and manage money for financial planning and monetary goals.

In the present invention, a user creates an online account. Within this online account, a user creates and funds a Money Cloud for a specific intention (vacation, gadget, vehicle, etc.). Once the user adds this Money Cloud to the Cloud Market, participating merchants and/or other interested parties have visibility to the Money Cloud's intention and relevant details. Parties may then bid on this Money Cloud with those goods or services that match the intention.

The uses and advantages of the present invention will be more evident after consideration of the specifications and drawings provided.

### SUMMARY OF INVENTION

To address the shortcomings of the background art, one aspect of the present invention provides a system and method for a plurality of bidders to place bids on a user's Money Cloud that has been created, funded, and explicitly added to the Cloud Market. The user's Money Cloud encompasses and contains all of the intentions and preferences requested for a particular good and/or service set by that user via a system provided user interface.

By a plurality of bidders bidding on a single, available Money Cloud at a time, each individual Money Cloud owner will receive more favorable terms.

### BRIEF DESCRIPTION OF THE FIGURES

FIG. 1 is a block diagram illustrating the high-level e-commerce environment.

FIG. 2 is a block diagram illustrating the high-level platform architecture.

FIG. 3A is a flow chart illustrating the user account creation process.

FIG. 3B is a wireframe illustrating the Create Account interface.

FIG. 4A is a flow chart illustrating the funding source creation process.

FIG. 4B is a wireframe illustrating the Create Funding Source interface.

FIG. 5A is a flow chart illustrating the Money Cloud creation process.

FIG. 5B is a wireframe illustrating the Create Money Cloud interface.

FIG. 6 is a wireframe illustrating the interface for adding a Money Cloud to the Cloud Market.

FIG. 7A is a flow chart illustrating the bidding process.

FIG. 7B is a wireframe illustrating the Cloud Market interface.

### DETAILED DESCRIPTION OF THE INVENTION

A system and method for performing merchant bidding is disclosed. In the following description and for the purposes of the explanation, numerous and specific details are set forth in order to provide a thorough understanding of the embodiment of the present invention.

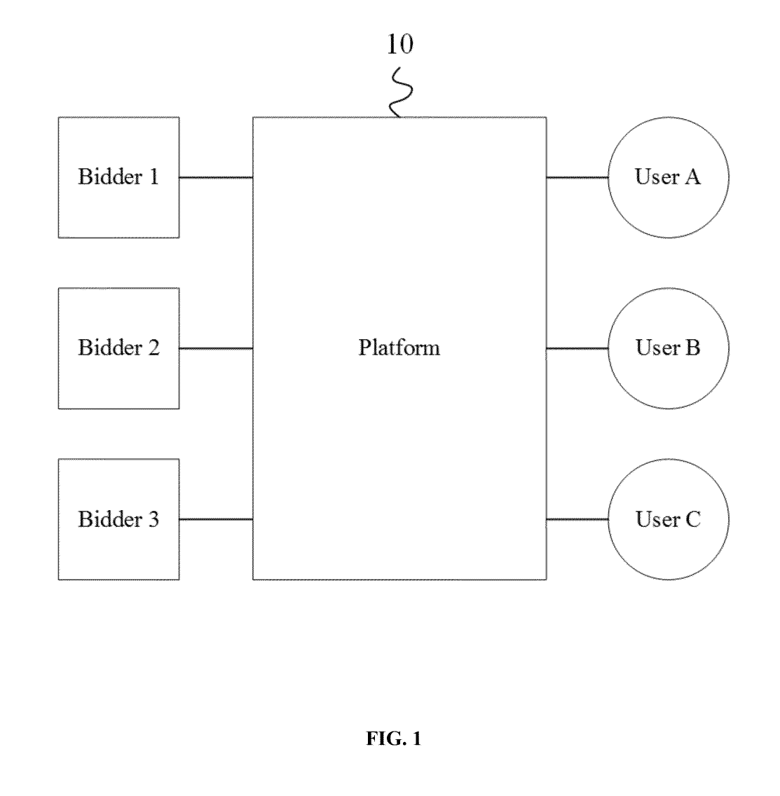

FIG. 1 shows the first embodiment and overview of the e-commerce environment. In this example, a limited number of users is illustrated and used only by way of example. In actual implementation, it is intended that the system, according to the invention, will utilize a network, such as the internet, having a large number of users accessing the system.

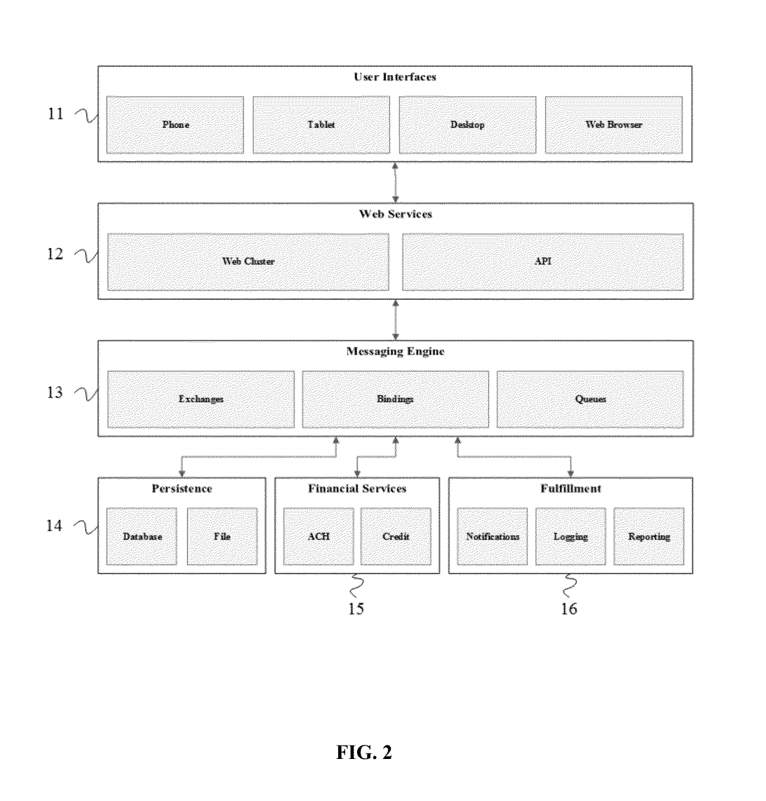

The architecture of a preferred embodiment of the invention is shown in FIG. 2. The implementation of the architecture will be readily apparent to those skilled in the art because of the use of standard components, technologies, functionality, and interrelation and need not be described in detail here. For the sake of simplicity, the term “Platform” shall be used to maintain consistency as also referenced in FIG. 1.

As illustrated in FIG. 2, the apparatus of the present invention is a collection of subsystems which is comprised of user interfaces 11, web services 12, messaging engine 13, persistence mechanisms 14, financial services 15, and fulfillment mechanisms 16 which interact with each other at various levels to facilitate the merchant bidding process.

The first subsystem, comprised of user interfaces 11, includes any interface that provides users with access to the Platform 10. The interfaces may be of any type known in the art, including but not limited to, a mobile device, tablet, desktop, or any device having capability of communicating over a network and/or a web browser.

The second subsystem, comprised of web services 12, is the gateway for any request initiated by the user interface. The subsystem may include web clusters which is defined as a collection of servers usually maintained by an enterprise to accomplish computational needs and an Application Programming Interface to communicate with various software components.

The third subsystem, comprised of a messaging engine 13, is responsible for brokerage of requests coming to and from other subsystems.

The fourth subsystem, comprised of persistence mechanisms 14, encompasses different database and file systems and is responsible for the temporary and/or permanent storage of information that is required across all subsystems.

The fifth subsystem, comprised of financial services 15, is responsible for initiating, facilitating, and managing the flow of funds into and out of the Platform 10.

The sixth subsystem, comprised of fulfillment mechanisms 16, is responsible for communicating with users via external vehicles, keeping track of all Platform 10 activity, and providing any necessary reporting and visualizations.

Each subsystem can be configured using a distributed design wherein tasks can be executed in separate and/or concurrent units or locations with each subsystem being connected via software, local area network, and/or wide area network.

There are a variety of ways in which one of ordinary skill in the art might architect the invention, including combining many servers and databases into a more condensed architecture to utilize less physical hardware, that are well known to those of ordinary skill in the art and which need not be described further here.

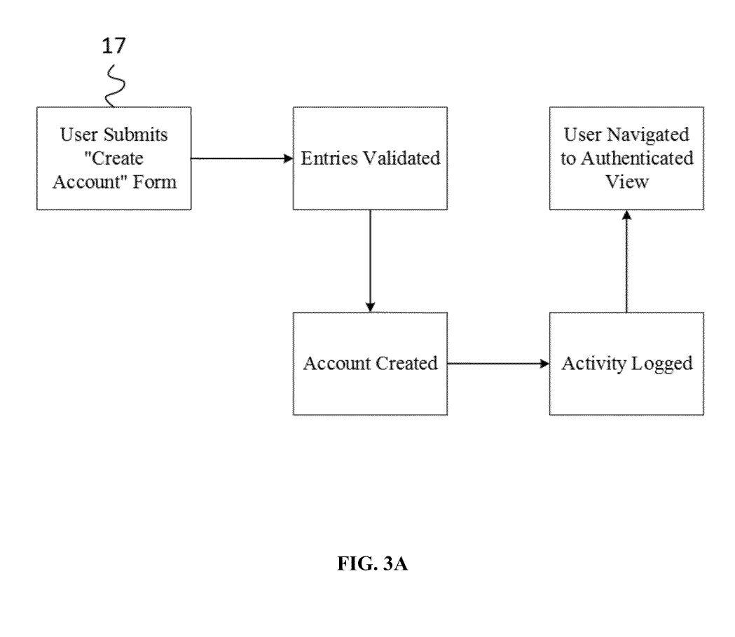

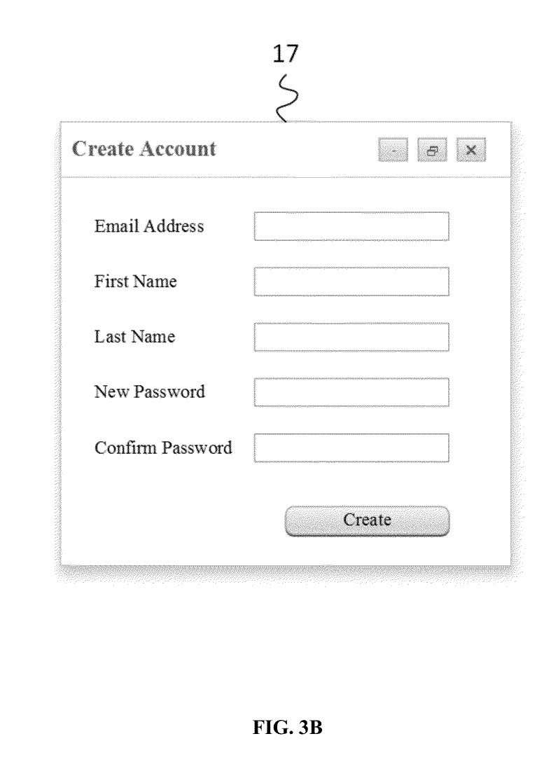

As the first step, a user and/or bidder has to create an account on the Platform 10 and FIG. 3 illustrates the account creation process. The Platform 10 includes an interface that facilitates a user's creation and/or opening of a new account. A user or bidder accesses the account creation form 17 using one of the Platform's user interfaces 11.

The user and/or bidder fills out and submits the account creation form 17 which may include fields related to credentials (allowing future access) and other personal information (as required to accurately identify the owner of the account). After the submission of this account creation form 17, the Platform 10 validates the entries provided, facilitates correction of invalid or inaccurate data, and creates a new account storing this information and data using the Platform's 10 persistence subsystem 14.

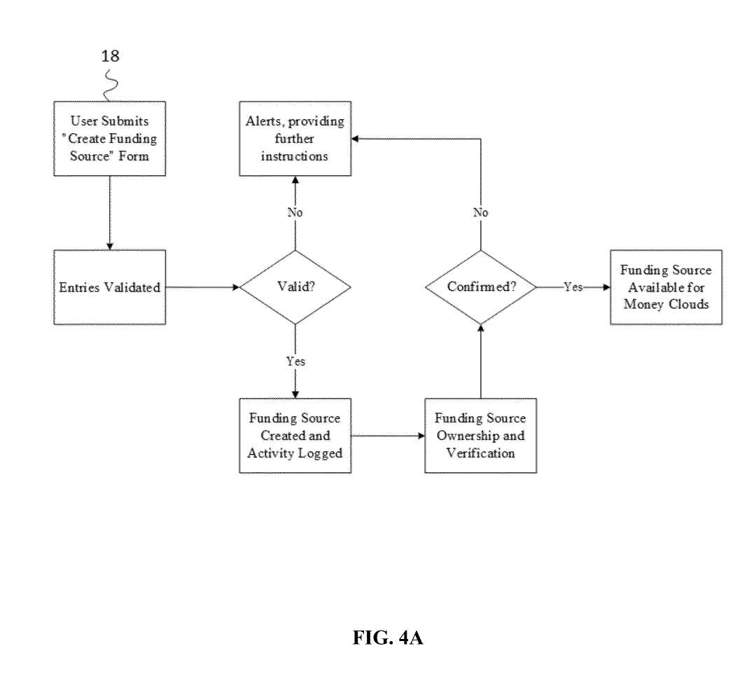

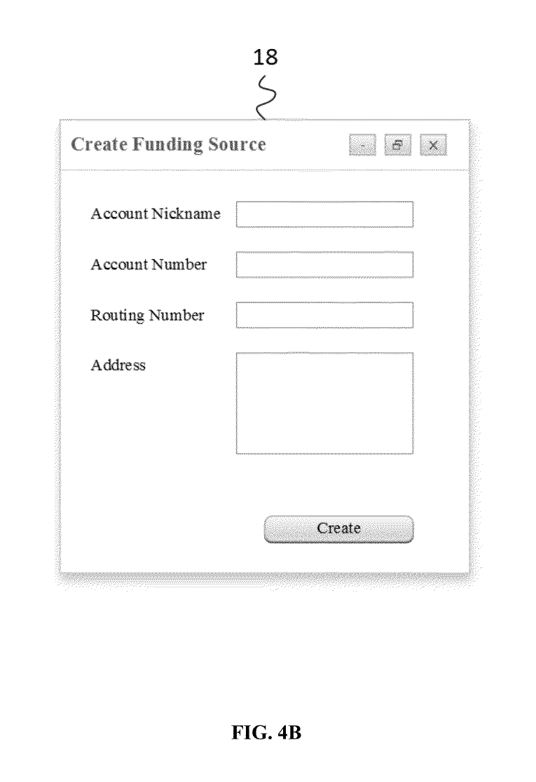

After the account is created, the user will have the option to add a funding source to his or her account which is necessary for adding funds to a Money Cloud. FIG. 4A illustrates the process of creating a funding source. The Platform 10 includes an interface that facilitates a user's addition of a funding source. A user or bidder accesses the funding source creation form 18 using one of the Platform's 10 user interfaces 11.

The user and/or bidder fills out and submits the funding source creation form 18 which may include fields related to identifying the funding source and other pertinent information as required. After the submission of this funding source creation form 18, the Platform 10 validates the entries provided, facilitates correction of invalid or inaccurate data, executes a funding source ownership and verification process, and once confirmed, adds a new funding source to the account storing this information and data using the Platform's 10 persistence subsystem 14.

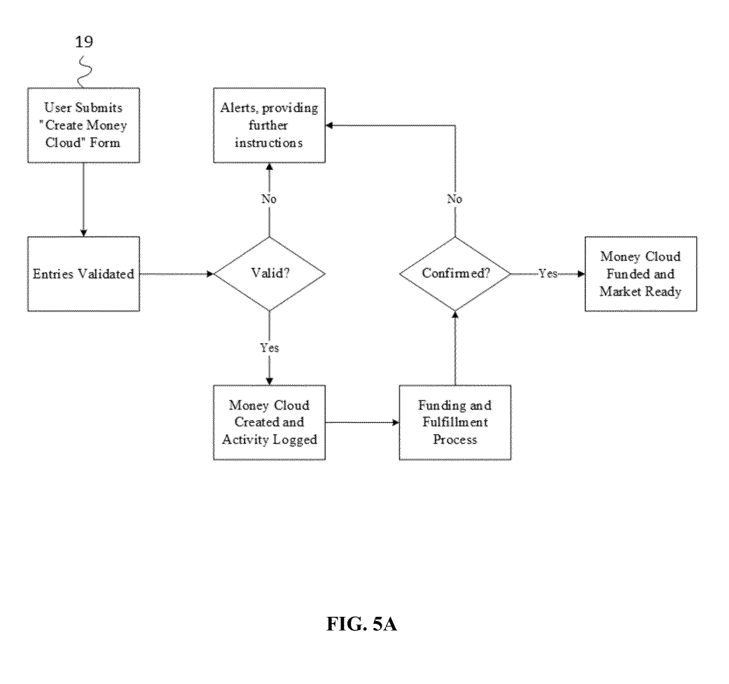

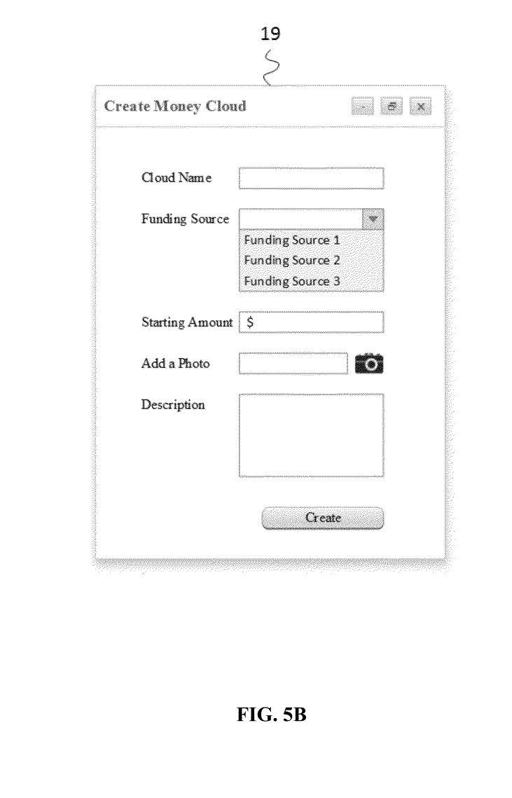

With the account created and a funding source added, the user has the option of creating a Money Cloud. FIG. 5A illustrates the process of creating a Money Cloud. The Platform 10 includes an interface that facilitates a user's creation of a Money Cloud. A user accesses the Money Cloud creation form 19 using one of the Platform's 10 user interfaces 11.

The user fills out and submits the Money Cloud creation form 19 which may include fields related to identifying the Money Cloud and other pertinent information as required. After submission of this Money Cloud creation form 19, the Platform 10 validates the entries provided, facilitates correction of invalid or inaccurate data, executes a funding and fulfillment process, and once confirmed, adds a new Money Cloud to the account storing this information and data using the Platform's 10 persistence subsystem 14.

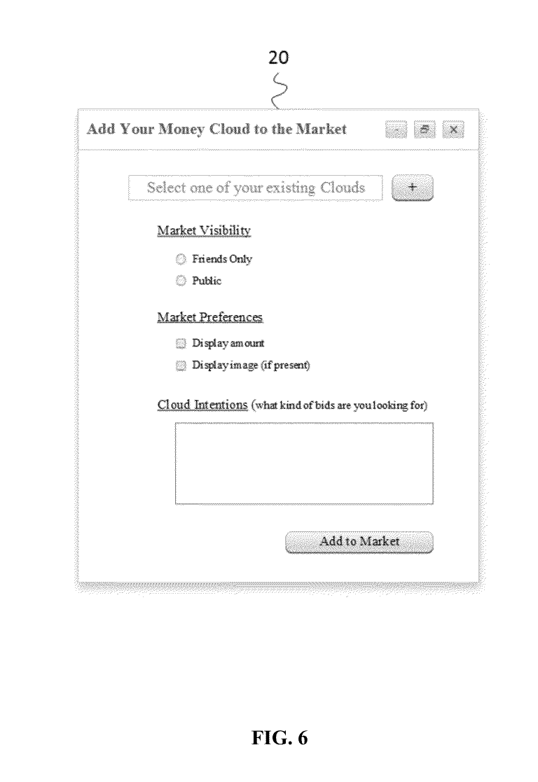

Once a user has a funded Money Cloud, the user has the option of adding that Money Cloud to the Cloud Market. The Platform 10 includes an interface that facilitates adding a Money Cloud to the Cloud Market and FIG. 6 illustrates that process using one of the Platform's 10 user interfaces 11.

The user fills out and submits the Cloud Market addition form 20 which may include fields related to identifying the Money Cloud and other pertinent information as required. After submission of this Cloud Market addition form 20, the Platform 10 validates the entries provided, facilitates correction of invalid or inaccurate data, and lists the newly added Money Cloud in the Cloud Market storing this information and data using the Platform's 10 persistence subsystem 14.

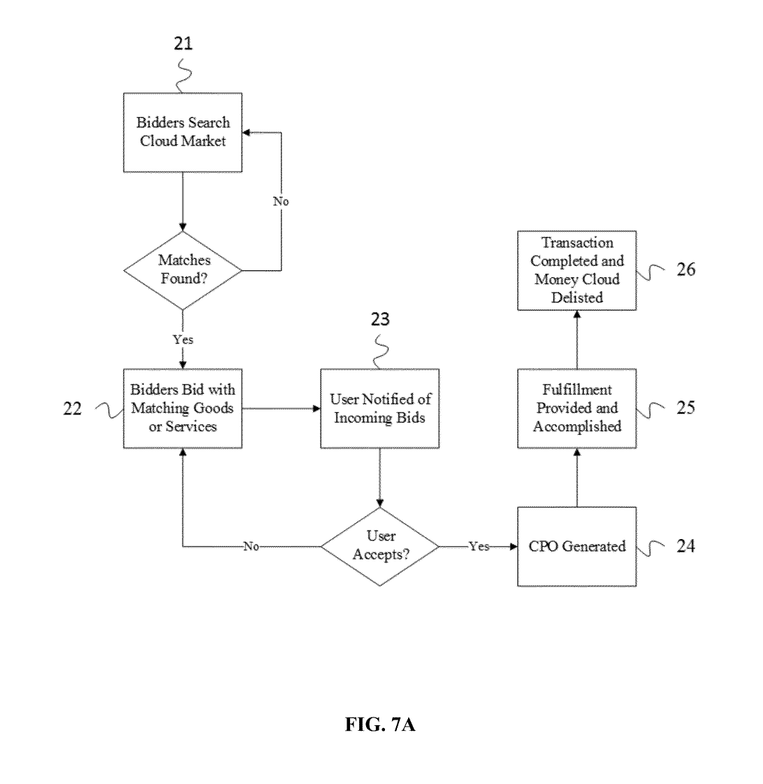

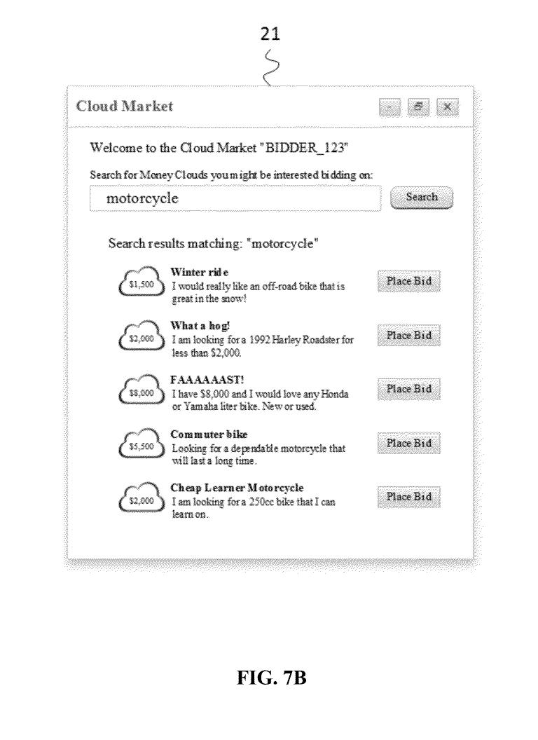

With funded Money Clouds listed in the Cloud Market, bidders have the option of searching for and bidding on Money Clouds where the intentions and preferences match those of the bidder's goods and/or services. FIG. 7A illustrates the process of searching for and bidding on a Money Cloud listed in the Cloud Market. The Platform 10 includes an interface that facilitates a bidder's search for Money Clouds. A bidder accesses the Cloud Market search form 21 using one of the Platform's 10 user interfaces 11.

Using the functionality on the Cloud Market search form 21, a bidder may use keywords and/or other tools provided to obtain a list of Money Clouds that match the given search criteria. FIG. 7B illustrates an example of a keyword search resulting in a listing of matching Money Clouds.

At this stage, the Platform 10 will allow multiple bidders to place bids 22 on Money Clouds participating and listed in the Cloud Market.

A user will be notified by the Platform 10 of the bids on his or her Money Cloud either by text, email, or any other notification methods 23. These bids are organized into a hierarchy based on past transaction history, reviews, and product/service ratings. It is a goal of the present invention to provide a robust system that matches a user's requirements with bidders satisfying those requirements.

After the user has selected a bid, the platform 10 will generate a Conditional Purchase Offer (CPO) 24. Each CPO will include information, detail, and data required to facilitate an agreement between the two parties.

Upon the requirements of the CPO having been satisfied by both parties, the Platform 10 will facilitate the payment process, provide receipts, log activity, and delist the Money Cloud from the Cloud Market 25.

The invention allows users to reach a large number of remotely located sellers who normally would be inaccessible.

Those skilled in the art will recognize that the method of the present invention has many applications and is not limited to the representative examples disclosed herein.

We claim:

1. A computer implemented method for facilitating merchant bidding in an internet based, user driven e-commerce market (“Cloud Market”) by enabling bidders to place bids on a user's allocated funds (“Money Cloud”) using the bidder's specific goods and/or services for which align with the user's advertised intentions.

2. The computer implemented method of claim 1, wherein a user saves money towards a specific goal in an online platform.

3. The computer implemented method of claim 1, wherein the user shares the Money Cloud with friends and family.

4. The computer implemented method of claim 1, wherein friends and family of a user contribute to a Money Cloud and other goals as set by the user.

5. The computer implemented method of claim 1, wherein merchants or other interested parties bid on users' Money Clouds.
